(19) United States
(12) Patent Application Publication
(10) Pub. No.: US 2007/0149661 A1
(43) Pub. Date: Jun. 28, 2007

(54) POLYCARBONATE COMPOSITION, METHOD OF MANUFACTURE THEREOF AND ARTICLES COMPRISING THE SAME

(76) Inventors: Sanjay Gurbasappa Charati, Bangalore (IN); Manjunath Hr, Bangalor-Karnataka (IN); Hua Huang, Shanghai (CN); Ramya Kumaraswamy, Bangalore (IN); Huagui Yang, Shanghai (CN)

Correspondence Address: CANTOR COLBURN, LLP, 55 GRIFFIN ROAD SOUTH, BLOOMFIELD, CT, 06002, US

(21) Appl. No.: 11/611,376

(22) Filed: Dec. 15, 2006

Related U.S. Application Data
(60) Provisional application No. 60/753,904, filed on Dec. 23, 2005.

(51) Int. Cl. C08K 5/49; C08K 3/40; C08K 3/04

(52) U.S. Cl. 524/115; 524/494; 524/495

(57) ABSTRACT

Disclosed herein is composition comprising a polycarbonate composition; a fibrous reinforcing composition comprising glass fibers or a combination of glass fibers and carbon fibers; and a flame retardant composition comprising a phosphorus based flame retardant; and a synergist composition; wherein the composition has a flame retardancy of V-1 or better for a sample having a thickness of up to about 1.6 millimeters as measured in a UL-94 test and a heat distortion temperature of greater than or equal to about 75° C. when subjected to a deforming force of about 1.8 megapascals.

### CROSS REFERENCE TO RELATED APPLICATIONS

This application claims priority to U.S. Provisional Application Ser. No. 60/753,904 filed on Dec. 23, 2005, which is incorporated in its entirety by reference herein.

### BACKGROUND

This disclosure relates to a polycarbonate composition, methods of manufacture thereof and articles comprising the same.

The exterior body of computer laptops generally comprises a die cast metal. Die cast metals provide the laptop with desirable aesthetics. Examples of metals that are die cast are aluminum and magnesium. While the use of die cast metals provides the computer with a number of desirable capabilities, die casting of metals is expensive. In addition, using a die cast metal increases the weight of the laptop.

In order to reduce the weight of the laptop and to improve manufacturing flexibility, it is desirable to use polymeric materials for the exterior body instead of die cast metals. Polymeric materials are generally flammable and have heat distortion temperatures that cannot withstand the temperatures generated in the laptop.

It is therefore desirable to modify a polymeric material for use in the exterior body of laptops that combines flammability resistance with heat distortion temperatures that can withstand temperatures generated in the laptop.

### SUMMARY

Disclosed herein is composition comprising a polycarbonate composition; a fibrous reinforcing composition comprising glass fibers or a combination of glass fibers and carbon fibers; and a flame retardant composition comprising a phosphorus based flame retardant; and a synergist composition; wherein the composition has a flame retardancy of V-1 or better for a sample having a thickness of up to about 1.6 millimeters, as measured in a UL-94 test and a heat distortion temperature of greater than or equal to about 75° C. when subjected to a deforming force of about 1.8 megapascals.

Disclosed herein too is a composition comprising a polycarbonate composition; a fibrous reinforcing composition comprising glass fibers or a combination of glass fibers and carbon fibers; about 1 to about 10 wt % of a flame retardant composition; wherein the flame retardant composition comprises a phosphorus based flame retardant; and about 1 to about 10 wt % of a synergist composition.

Disclosed herein too is a method comprising melt blending a composition comprising a polycarbonate composition; a fibrous reinforcing composition comprising glass fibers or a combination of glass fibers and carbon fibers; and a flame retardant composition comprising a phosphorus based flame retardant composition and a synergist composition; wherein the composition has a flame retardancy of V-1 or better at a sample thickness of up to about 1.6 millimeters, as measured in a UL-94 test and a heat distortion temperature of greater than or equal to about 75° C. when subjected to a deforming force of about 1.8 megapascals.

### DETAILED DESCRIPTION

It is to be noted that the terms “first,” “second,” and the like as used herein do not denote any order, quantity, or importance, but rather are used to distinguish one element from another. The terms “a” and “an” do not denote a limitation of quantity, but rather denote the presence of at least one of the referenced item. The modifier “about” used in connection with a quantity is inclusive of the stated value and has the meaning dictated by the context (e.g., includes the degree of error associated with measurement of the particular quantity). It is to be noted that all ranges disclosed within this specification are inclusive and are independently combinable. All weight percents described herein are based on the total weight of the composition unless otherwise stated.

Disclosed herein is a composition that comprises a polycarbonate composition that can be used for the exterior body of a computer laptop. In an advantageous embodiment, the composition has a heat distortion temperature that is greater than the temperatures generated by the computer. The composition is also advantageous in that it is flame retardant while being devoid of a halogen flame retardant and possesses a notched Izod impact strength of greater than or equal to about 50 Joules/meter.

The composition comprises a polycarbonate composition, a fibrous reinforcing composition, a synergist composition and a flame retardant composition that comprises a phosphorus based flame retardant. The presence of the flame retardant composition and the synergist composition reduces the amount of the flame retardant used especially when compared with other comparative compositions that do not comprise the synergist. Comparative compositions that do not comprise the synergist composition generally use amounts of flame retardant that exceed 10 wt %, based on the weight of the composition. The presence of the flame retardant composition in an amount of greater than or equal to about 10 wt % causes a decrease in the impact properties of the composition and a reduction in the heat distortion temperature.

The polycarbonate composition generally comprises a polycarbonate. The polycarbonate composition can comprise a polycarbonate homopolymer, a polycarbonate copolymer such as a star block copolymer, a graft copolymer, an alternating block copolymer or a random copolymer, a polycarbonate ionomer, a polycarbonate dendrimer, or a combination comprising at least one of the foregoing. The polycarbonate composition may also comprise a blend of polymers, copolymers, terpolymers, or the like, or a combination comprising at least one of the foregoing, so long as polycarbonate is present.

Examples of polycarbonate blends are polycarbonate/acrylonitrile-butadiene-styrene, polycarbonate/polyester, polycarbonate/polyarylate, polycarbonate-polysiloxane copolymer blended with polycarbonate, or the like, or a combination comprising at least one of the foregoing.

Examples of suitable copolymers that comprise polycarbonate are polycarbonate-polysiloxane copolymers, polycarbonate-polyester copolymers (also known as copolyestercarbonates), polycarbonate-polyarylate copolymers, or the like, or a combination comprising at least one of the foregoing copolymers. Examples of suitable blends that comprise polycarbonate copolymers are a polycarbonate-polysiloxane copolymer blended with polycarbonate, a polycarbonate-polysiloxane copolymer blended with polycarbonate and acrylonitrile-butadiene-styrene, a polycarbonate-polyester copolymer blended with either polycarbonate or polyester or both, a polycarbonate-polyarylate copolymer blended with polycarbonate, polyester, polyarylate, or a combination comprising at least one of polycarbonate, polyester or polyarylate.

In one embodiment, the composition comprises about 5 to about 70 weight percent (wt %) of the polycarbonate composition. In another embodiment, the composition comprises about 10 to about 65 wt % of the polycarbonate composition. In yet another embodiment, the composition comprises about 20 to about 60 wt % of the polycarbonate composition. In yet another embodiment, the composition comprises about 40 to about 45 wt % of the polycarbonate composition.

The fibrous reinforcing composition can comprise glass fibers and/or carbon fibers. The glass fibers and the carbon fibers may be present in the composition in the form of monofilament or multifilament fibers and can be used either alone or in combination with other types of fiber, through, for example, co-weaving or core/sheath, side-by-side, orange-type or matrix and fibril constructions, or the like. The fibrous reinforcing composition may be added to the composition in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, preforms and braids.

In an exemplary embodiment, the glass fibers are used in a non-weave form in the composition. Useful glass fibers can be formed from fiberizable glass compositions commonly known as “E-glass,” “A-glass,” “C-glass,” “D-glass,” “R-glass,” “S-glass,” as well as E-glass derivatives that are fluorine-free and/or boron-free. An exemplary glass is a commercially available glass fiber trademarked FIBERGLASS® 415CA. The glass fibers may be sized or unsized. Sized glass fibers are coated on at least a portion of their surfaces with a sizing composition selected for compatibility with the polymeric matrix material. The sizing composition facilitates wet-out and wet-through of the matrix material upon the fiber strands and assists in attaining desired physical properties in the composite.

Commercially produced glass fibers generally having average filament diameters of about 4 to about 35 micrometers can be used in the composition. In one embodiment, the glass fibers have average filament diameters of about 6 to about 30 micrometers. In another embodiment, the glass fibers have average filament diameters of about 7 to about 25 micrometers. In yet another embodiment, the glass fibers have average filament diameters of about 8 to about 20 micrometers.

Carbon fibers can be used in the composition in conjunction with the glass fibers. The carbon fibers can be pitch or polyacrylonitrile (PAN) based fibers. The carbon fibers have the same nominal diameters as those for the glass fibers listed above. A sizing agent can be applied to the carbon fibers if desired.

Polymeric fibers may optionally be added to the fibrous reinforcing composition. In one embodiment, the polymeric fibers may be short fibers having a length of less than or equal to about 2 millimeters. In another embodiment, the polymeric fibers may be long fibers having lengths of greater than 2 millimeters to about 25 millimeters. The fibers may be sized with a sizing agent if desired.

Exemplary polymeric fibers are KEVLAR® and NOMEX® both of which are polyaramids commercially available from DuPont or SPECTRA®, an ultrahigh molecular weight polyethylene fiber commercially available from Honeywell Corporation. Fibers derived from other polymers such as polypropylene, polyethylene terephthalate, polyamides such as for example Nylon 6 and Nylon 6, 6, cellulose, polyacrylonitrile, polyurethane, or the like, or a combination comprising at least one of the foregoing polymers may also be used in the composition.

In one embodiment, the composition comprises about 5 to about 60 wt % of the fibrous reinforcing composition. In another embodiment, the composition comprises about 27 to about 57 wt % of the fibrous reinforcing composition. In yet another embodiment, the composition comprises about 35 to about 45 wt % of the fibrous reinforcing composition. In yet another embodiment, the composition comprises about 40 to about 43 wt % of the fibrous reinforcing composition.

The fibrous reinforcing composition can optionally comprise non-fibrous fillers. Examples of such fillers are famed silica, famed alumina, alumina, talc, mica, feldspar, silicate spheres, glass flakes, aluminosilicate (atmospheres), quartz, quartzite, diatomaceous earth, silicon carbide, molybdenum sulfide, zinc sulfide, aluminum silicate (mullite), synthetic calcium silicate, zirconium silicate, barium titanate, barium ferrite, barium sulfate, or the like, or a combination comprising at least one of the foregoing non-fibrous fillers.

The composition can comprise about 5 to about 20 wt % of non-fibrous fillers. In one embodiment, the composition can comprise about 8 to about 18 wt % of non-fibrous fillers. In another embodiment, the composition can comprise about 10 to about 16 wt % of non-fibrous fillers. An exemplary composition comprises about 15 wt % of the non-fibrous fillers.

The flame retardant composition comprises a phosphorus-based flame retardant. The phosphorus-based flame retardant comprises an organic phosphate. In one embodiment, the organic phosphate is an aromatic phosphate compound of the formula (I):

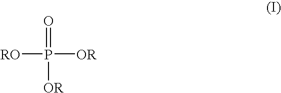

wherein each R is the same or different and is preferably an alkyl, a cycloalkyl, an aryl, an alkyl substituted aryl, a halogen substituted aryl, an aryl substituted alkyl, a halogen, or a combination of at least one of the foregoing phosphate compounds provided at least one R is aryl. An exemplary phosphate is one in which each R in the formula (I) is aryl.

Examples of suitable organic phosphates include phenyl bis(dodecyl) phosphate, phenyl bis(neopentyl)phosphate, phenyl bis(3,5,5′-trimethylhexyl phosphate), ethyl diphenyl phosphate, 2-ethylhexyl bis(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, tricresyl phosphate, triphenyl phosphate, dibutylphenyl phosphate, 2-chloroethyl diphenyl phosphate, p-tolyl bis(2,5,5′-trimethylhexyl)phosphate, 2-ethylhexyl diphenyl phosphate, and the like. An exemplary organic phosphate is triphenyl phosphate. The triphenyl phosphate can be substituted or unsubstituted.

Alternatively, the organic phosphate can be a di- or polyfunctional compound or polymer having the formula (II), (III), or (IV) below:

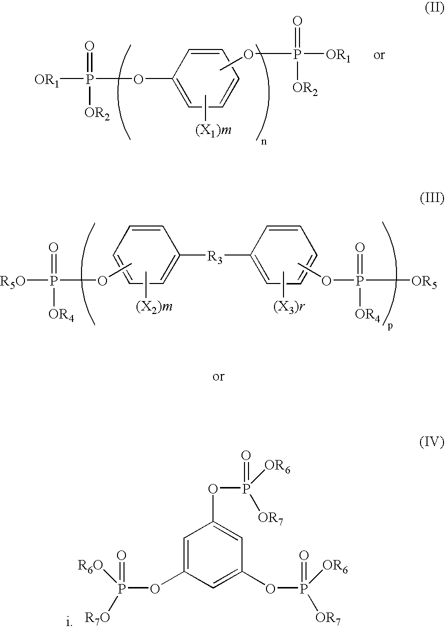

including mixtures thereof, in which R₁, R₃ and R₅ are independently hydrocarbon; R₂, R₄, R₆ and R₇ are independently hydrocarbon or hydrocarbonoxy; X₁, X₂ and X₃ are halogen; m and r are 0 or integers from 1 to 4, and n and p are integers from 1 to 30.

Examples of di- and polyfunctional phosphate compounds include the bis(diphenyl phosphates) of resorcinol, hydroquinone and bisphenol-A, respectively, or their polymeric counterparts. Another group of useful flame-retardants include certain cyclic phosphates, for example, diphenyl pentaerythritol diphosphate.

Also suitable as flame-retardant additives are the phosphoramides of the formula (V):

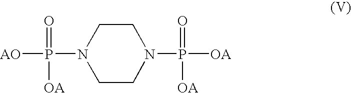

wherein each A is a 2,6-dimethylphenyl moiety or a 2,4,6-trimethylphenyl moiety. These phosphoramides are piperazine-type phosphoramides.

The flame retardant composition may comprise a single phosphate compound or a mixture of two or more different types of phosphate compounds. Compositions comprising essentially a single phosphate compound are preferred. Exemplary phosphate flame-retardants include those based upon resorcinol such as resorcinol bis(diphenyl phosphate) (hereinafter RDP), as well as those based upon bisphenols such as, for example, bisphenol A bis(diphenyl phosphate) (hereinafter BPADP) or N,N′-bis[di-(2,6-xylyl)phosphoryl]-piperazine (hereinafter XPP), and mixtures thereof, with BPADP being the most desirable.

The composition can comprise about 1 to about 10 wt % of the flame retardant composition. In one embodiment, the composition can comprise about 2 to about 9 wt % of the flame retardant composition. In another embodiment, the composition can comprise about 3 to about 7 wt % of the flame retardant composition. In yet another embodiment, the composition can comprise about 4 to about 6 wt % of the flame retardant composition. In an exemplary embodiment, the composition can comprise about 5 wt % of the flame retardant composition.

As noted above, a synergist composition can be added to the composition. The synergist composition facilitates the activation and sustenance of the flame retardant properties of the flame retardant composition. In one embodiment, the synergist composition comprises an intumescing agent that facilitates the formation of a char during the burning of the composition. The formation of a char reduces the flammability of the composition. The presence of the synergist composition also enhances smoke suppression.

Examples of synergists are alumina trihydrate, aluminum hydroxide, magnesium hydroxide, zeolite, zinc borate, mica, polysiloxanes, intercalated graphite, or the like, or a combination comprising at least one of the foregoing synergists. Exemplary polysiloxanes are dimethyl polysiloxane, methylphenyl polysiloxane, diphenyl polysiloxane, or the like, or a combination comprising at least one of the foregoing polysiloxanes.

The composition can comprise the synergist composition in an amount of about 1 to about 10 wt %. In one embodiment, the composition can comprise the synergist composition in an amount of about 2 to about 9 wt %. In another embodiment, the composition can comprise the synergist composition in an amount of about 3 to about 8 wt %. In yet another embodiment, the composition can comprise the synergist composition in an amount of about 4 to about 7 wt %. In an exemplary embodiment, the composition can comprise about 5 wt % of the synergist.

Other additives such as flow control agents, thermal stabilizers, antioxidants, mold release agents, viscosity modifiers, plasticizers, or the like, can be added to the composition in desirable amounts.

In one embodiment, in one method of manufacturing the composition, the polycarbonate composition, the flame retardant composition, the flame retardant agent, the synergist composition and other optional additives are compounded by melt blending the composition.

Melt blending of the composition involves the use of shear force, extensional force, compressive force, ultrasonic energy, electromagnetic energy, thermal energy or a combination comprising at least one of the foregoing forces or forms of energy and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or a combination comprising at least one of the foregoing.

Melt blending involving the aforementioned forces may be conducted in machines such as, but not limited to, single or multiple screw extruders, Buss kneader, Henschel, helicones, Ross mixer, Banbury, roll mills, molding machines such as injection molding machines, vacuum forming machines, blow molding machine, or the like, or a combination comprising at least one of the foregoing machines. The composition is generally melt blended in an extruder. Examples of extruders that can be used for the melt blending are single or twin screw extruders. An exemplary extruder is a twin screw extruder.

In one embodiment, the polymeric material in powder form, pellet form, sheet form, or the like, may be first dry blended with the fibrous reinforcing composition, the flame retardant composition, the synergist composition and other optional additives if desired in a Henschel or a roll mill, prior to being fed into a melt blending device such as an extruder or Buss kneader. In another embodiment, the fibrous reinforcing composition is introduced into the melt blending device in the form of a masterbatch. In such a process, the masterbatch may be introduced into the melt blending device downstream of the polymeric material.

When a masterbatch is used, the masterbatch comprises about 40 to about 80 wt % of the fibrous reinforcing composition. In another embodiment, the masterbatch comprises about 50 to about 75 wt % of the fibrous reinforcing composition. An exemplary masterbatch comprises about 60 wt % of the fibrous reinforcing composition.

The masterbatch is diluted during processing with the desired polycarbonate composition. In one embodiment, when an extruder is used to manufacture the composition, the masterbatch may be fed into the throat of the extruder along with the desired polycarbonate composition. In another embodiment, the polycarbonate composition is fed into the throat of the extruder, while the masterbatch is added downstream of the throat. By adding the masterbatch downstream, the aspect ratio of the fibers in the fibrous reinforcing composition can be preserved.

The composition comprising the polycarbonate composition, the fibrous reinforcing composition, the flame retarding composition and the synergist composition may be subjected to multiple blending and forming steps if desirable. For example, the composition may first be extruded and formed into pellets. The pellets may then be fed into a molding machine where it may be formed into other desirable shapes. The composition can be injection molded, compression molded, blow molded, vacuum formed, or subjected to manufacturing processes that combine the aforementioned molding processes. Alternatively, the composition emanating from a single melt blender may be formed into sheets or strands and subjected to post-extrusion processes such as annealing, uniaxial or biaxial orientation.

The composition has a number of advantageous properties that make it very useful for the exterior body in computers, laptop computers, electronics, television sets, or the like. In one embodiment, the composition has a flame retardancy of V-2 or better as measured in a UL-94 Underwriters Laboratory test for a sample having a thickness of 1.6 millimeters or thinner. In another embodiment, the composition has a flame retardancy of V-1 or better as measured in a UL-94 Underwriters Laboratory test for a sample having a thickness of 1.6 millimeters or thinner. In one embodiment, the composition displays a flame retardancy of V-0 in a UL-94 flame retardancy test for a sample having a thickness of 1.6 millimeters or thinner. Compositions used in UL-94 Underwriters Laboratory flame retardancy tests generally have thickness of about 0.8 to about 1.6 millimeters. In the examples of the present disclosure the samples used in the flame retardancy test had a thickness of about 1.2 millimeters. The composition does not utilize halogens and is therefore environmentally friendly.

The composition has a heat distortion temperature of greater than or equal to about 75° C. when subjected to a deforming force of about 1.8 MPa. In one embodiment, the composition has a heat distortion temperature of greater than or equal to about 85° C. when subjected to a deforming force of about 1.8 MPa. In another embodiment, the composition has a heat distortion temperature of greater than or equal to about 100° C. when subjected to a deforming force of about 1.8 MPa. In yet another embodiment, the composition has a heat distortion temperature of greater than or equal to about 105° C. when subjected to a deforming force of about 1.8 MPa.

The combination of a properties comprising a heat distortion temperature of greater than or equal to about 75° C., a notched Izod of greater than or equal to about 10 kiloJoules/square meter, and a flame retardancy of V-1 or better in a UL-94 flame retardancy test makes the composition useful for the exterior body in laptops, computers and other electronic items.

In one embodiment, the composition displays a notched Izod impact strength of greater than or equal to about 50 Joules/meter. In another embodiment, the composition displays a notched Izod impact strength of greater than or equal to about 60 Joules/meter. In yet another embodiment, the composition displays a notched Izod impact strength of greater than or equal to about 70 Joules/meter. In yet another embodiment, the composition displays a notched Izod impact strength of greater than or equal to about 80 Joules/meter.

The composition also is easily processable having a melt flow index of greater than or equal to about 15 when measured at 260° C. under a weight of 2.16 kilograms. In one embodiment, the composition has a melt from index of greater than or equal to about 17 when measured under the aforementioned conditions. In another embodiment, the composition has a melt from index of greater than or equal to about 20 when measured under the aforementioned conditions.

The following examples, which are meant to be exemplary, not limiting, illustrate compositions and methods of manufacturing of some of the various embodiments described herein.

### EXAMPLES

The following examples demonstrate the advantageous combination of properties offered by the composition. Six different compositions are shown in the Table 1 along with their properties. The compositions in Table 1 were extruded in a 37 millimeter twin-screw extruder (ZSK-40®) manufactured by Krupp, Werner and Pfleiderer. The length to diameter ratio (L/D) of the twin-screw extruder is 41. The compositions in Table 1 were extruded under the following conditions. The extruder had 11 barrels or heating zones set at temperatures of 50° C., 100° C., 280° C., 280° C., 280° C., 280° C., 280° C., 280° C., 280° C., 280° C. and 280° C. The die temperature was set at 280° C. The extruder was run at 300 rpm. The extrusion rate was 30 idlograms per hour. The strand emanating from the extruder was pelletized, dried and subjected to injection molding to manufacture the test parts. The molding machine was a Cincinnati 220T. The amounts of each component employed in the various compositions are shown in Tables 1. All components were added directly to the extruder during extrusion.

The components are as follows: The polycarbonate used was Lexan 105 commercially available from GE Advanced Materials. The stabilizers used were a combination of Alkanox 240 and Irganox 1076. Alkanox 240 is commercially available from Great Lakes Chemical Company, while Irganox 1076 is commercially available from Ciba. The mold release was either a polyethylene wax or pentaerythritol tetrastearate or a combination of the two. The glass fiber was OCF 415 CA commercially available from Owens Corning Fiber. The zinc borate used was Firebrake ZB commercially available from the Borax Polymer additives group. Non-fibrous fillers used were talc or alumina or a combination of the two.

Following extrusion and injection molding, the samples were subjected to testing. Tensile testing was conducted as per ASTM D 638. Impact testing was conducted as per ASTM D 256. Flexural testing was conducted as per ASTM D 790. The heat distortion temperature (HDT) test was conducted using a distortion force of about 1.8 MPa on samples having a thickness of 3.2 millimeters. Melt flow rate (MFR) was conducted at 300° C. using a shearing force of 1.2 kilograms.

TABLE 1

| | Control | | | | | | |
|---|---|---|---|---|---|---|---|
| | Sample | Sample #1 | Sample #2 | Sample #3 | Sample #4 | Sample #5 | Sample #6 |
| | (wt %) | (wt %) | (wt %) | (wt %) | (wt %) | (wt %) | (wt %) |
| Composition | | | | | | | |
| Polycarbonate | 52 | 47 | 46 | 50.2 | 50.2 | 46 | 38.7 |
| ABS | | | | | | | 5.0 |
| Stabilizers | 0.20 | 0.20 | 0.20 | 0.10 | 0.10 | 0.20 | 0.20 |
| Mold Release | 0.7 | 0.7 | 0.7 | 0.5 | 0.5 | 0.7 | 0.5 |
| Glass Fiber | 40.0 | 40.0 | 40.0 | 38.5 | 35.5 | 30.0 | 40.0 |
| Carbon Fibers | | | | | | 10.0 | |
| Non-Fibrous | 1.5 | 1.5 | 1.5 | 3.0 | 3.0 | 1.5 | 3.0 |
| Filler | | | | | | | |
| BPADP | 5.0 | 5.0 | 6.0 | 5.0 | 5.0 | 6.0 | 5.0 |
| Encapsulated | 0.6 | 0.6 | 0.6 | 0.6 | 0.6 | 0.6 | 0.6 |
| PTFE | | | | | | | |
| PC-Siloxane | | | 5.0 | | | 5.0 | 5.0 |
| copolymer | | | | | | | |
| Zinc Borate | | 5.0 | | | | | 2.0 |
| Zeolites | | | | 2.0 | | | |
| Mica | | | | | 5.0 | | |
| Properties | | | | | | | |
| Notched Izod (J/M) | 85 | 81 | 97 | NA | NA | 54.5 | 78.4 |
| Flexural Modulus | 11.1 | 11.9 | 10.8 | 8.2 | 10.2 | 12.8 | 10.6 |
| (GPa) | | | | | | | |
| HDT (° C.) | 104 | 103 | 104 | 103 | 106 | 105 | 106 |
| at 1.8 MPa | | | | | | | |
| FR rating (UL-94) | No | V-0 | V-0 | V-0 | V-0 | V-0 | V-0 |
| | rating | at 1.2 mm | at 1.0 mm | at 1.0 mm | at 1.0 mm | at 1.0 mm | at 1.2 mm |

From the Table 1, it may be seen that by using a synergist composition such as a zeolite, zinc borate, mica along with the BPADP produces a flame retardant composition that has a heat distortion temperature (HDT) of 100° C. or greater. The synergy can be used to reduce the loading of glass fiber if desired.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A composition comprising:
a polycarbonate composition;
a fibrous reinforcing composition comprising glass fibers or a combination of glass fibers and carbon fibers; and
a flame retardant composition comprising a phosphorus based flame retardant; and
a synergist composition; wherein the composition has a flame retardancy of V-1 or better for a sample having a thickness of up to about 1.6 millimeters, as measured in a UL-94 test and a heat distortion temperature of greater than or equal to about 75° C. when subjected to a deforming force of about 1.8 megapascals.

2. The composition of claim 1, wherein the composition comprises the synergist is an amount of about 1 to about 10 wt %.

3. The composition of claim 2, wherein the synergist composition comprises polysiloxane, alumina trihydrate, aluminum hydroxide, magnesium hydroxide, zeolite, zinc borate, mica, intercalated graphite, or a combination comprising at least one of the foregoing synergists.

4. The composition of claim 1, wherein the composition comprises the flame retardant composition in an amount of about 1 to about 10 wt %.

5. The composition of claim 1, wherein the polycarbonate composition comprises polycarbonate, polycarbonate blended with acrylonitrile-butadiene-styrene, a polycarbonate-polysiloxane copolymer, a polycarbonate-polysiloxane copolymer blended with polycarbonate, a polycarbonate-polysiloxane copolymer blended with polycarbonate and acrylonitrile-butadiene-styrene, a polycarbonate-polyester copolymer, a polycarbonate-polyarylate copolymer, a polycarbonate-polysiloxane copolymer blended with polycarbonate, a polycarbonate-polysiloxane copolymer blended with polycarbonate and acrylonitrile-butadiene-styrene, a polycarbonate-polyester copolymer blended with either polycarbonate or polyester or both, a polycarbonate-polyarylate copolymer blended with polycarbonate, polyester, polyarylate, or a combination comprising at least one of polycarbonate, polyester or polyarylate or a combination comprising at least one of the foregoing polycarbonate compositions.

6. The composition of claim 1, comprising about 5 to about 70 wt % of the polycarbonate composition.

7. The composition of claim 1, comprising about 5 to about 60 wt % of the fibrous reinforcing composition.

8. The composition of claim 1, further comprising about 5 to about 20 wt % of non-fibrous fillers.

9. The composition of claim 1, wherein the phosphorus based flame retardant is an aromatic phosphate compound of the formula (I): 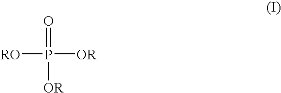
wherein each R is the same or different and is an alkyl, a cycloalkyl, an aryl, an alkyl substituted aryl, a halogen substituted aryl, an aryl substituted alkyl, a halogen, or a combination of at least one of the foregoing phosphate compounds provided at least one R is aryl.

10. The composition of claim 1, wherein the phosphorus based flame retardant comprises phenyl bis(dodecyl)phosphate, phenyl bis(neopentyl)phosphate, phenyl bis(3,5,5′-trimethylhexyl phosphate), ethyl diphenyl phosphate, 2-ethylhexyl bis(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, tricresyl phosphate, triphenyl phosphate, dibutylphenyl phosphate, 2-chloroethyl diphenyl phosphate, p-tolyl bis(2,5,5′-trimethylhexyl)phosphate, 2-ethylhexyl diphenyl phosphate or a combination comprising at least one of the foregoing flame retardants.

11. The composition of claim 1, wherein the phosphorus based flame retardant comprises a di- or polyfunctional compound or polymer having the formula (II), (III), or (IV) below: 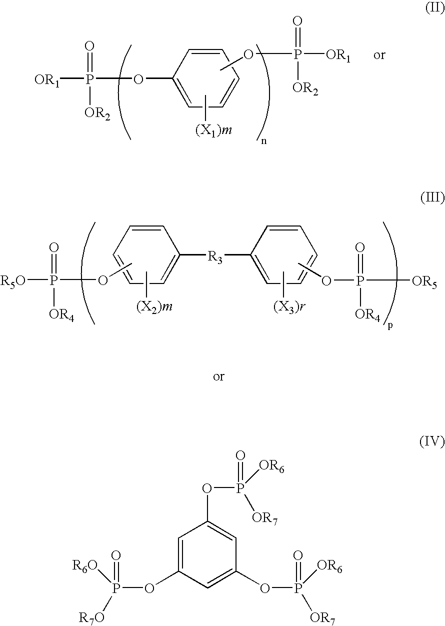
or mixtures thereof, in which R₁, R₃ and R₅ are independently hydrocarbon; R₂, R₄, R₆ and R₇ are independently hydrocarbon or hydrocarbonoxy; X₁, X₂ and X₃ are halogen; m and r are 0 or integers from 1 to 4, and n and p are integers from 1 to 30.

12. The composition of claim 1, wherein the phosphorus based flame retardant is bis(diphenyl phosphate), bisphenol A bis(diphenyl phosphate), N,N′-bis[di-(2,6-xylyl)phosphoryl]-piperazine or a combination comprising at least one of the phosphorus based flame retardants.

13. The composition of claim 1, comprising about 1 to about 9 wt % of the flame retardant composition and about 1 to about 9 wt % of the synergist composition.

14. An article manufactured from the composition of claim 1.

15. A composition comprising:
a polycarbonate composition;
a fibrous reinforcing composition comprising glass fibers or a combination of glass fibers and carbon fibers;
about 1 to about 10 wt % of a flame retardant composition; wherein the flame retardant composition comprises a phosphorus based flame retardant; and
about 1 to about 10 wt % of a synergist composition.

16. The composition of claim 15, wherein the synergist composition comprises alumina, alumina trihydrate, aluminum hydroxide, magnesium hydroxide, zeolite, zinc borate, antimony trioxide, antimony pentoxide, mica, intercalated graphite, or a combination comprising at least one of the foregoing synergists.

17. The composition of claim 15, wherein the polycarbonate composition comprises polycarbonate, polycarbonate blended with acrylonitrile-butadiene-styrene, a polycarbonate-polysiloxane copolymer, a polycarbonate-polysiloxane copolymer blended with polycarbonate, a polycarbonate-polysiloxane copolymer blended with polycarbonate and acrylonitrile-butadiene-styrene, a polycarbonate-polyester copolymer, a polycarbonate-polyarylate copolymer, a polycarbonate-polysiloxane copolymer blended with polycarbonate, a polycarbonate-polysiloxane copolymer blended with polycarbonate and acrylonitrile-butadiene-styrene, a polycarbonate-polyester copolymer blended with either polycarbonate or polyester or both, a polycarbonate-polyarylate copolymer blended with polycarbonate, polyester, polyarylate, or a combination comprising at least one of polycarbonate, polyester or polyarylate or a combination comprising at least one of the foregoing polycarbonate compositions.

18. The composition of claim 15, comprising about 5 to about 70 wt % of the thermoplastic polymer.

19. The composition of claim 15, wherein the phosphorus based flame retardant is an aromatic phosphate compound of the formula (I): 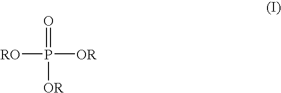
wherein each R is the same or different and is an allyl, a cycloalkyl, an aryl, an alkyl substituted aryl, a halogen substituted aryl, an aryl substituted alkyl, a halogen, or a combination of at least one of the foregoing phosphate compounds provided at least one R is aryl.

20. The composition of claim 15, wherein the phosphorus based flame retardant comprises phenyl bis(dodecyl)phosphate, phenyl bis(neopentyl)phosphate, phenyl bis(3,5,5′-trimethylhexyl phosphate), ethyl diphenyl phosphate, 2-ethylhexyl bis(p-tolyl)phosphate, bis(2-ethylhexyl)p-tolyl phosphate, tritolyl phosphate, bis(2-ethylhexyl)phenyl phosphate, tri(nonylphenyl)phosphate, bis(dodecyl)p-tolyl phosphate, tricresyl phosphate, triphenyl phosphate, dibutylphenyl phosphate, 2-chloroethyl diphenyl phosphate, p-tolyl bis(2,5,5′-trimethylhexyl)phosphate, 2-ethylhexyl diphenyl phosphate, or a combination comprising at least one of the foregoing flame retardants.

21. The composition of claim 15, wherein the phosphorus based flame retardant comprises a di- or polyfunctional compound or polymer having the formula (II), (III), or (IV) below: 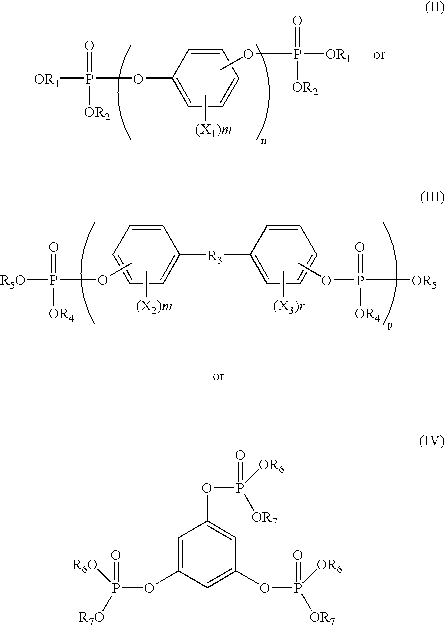
or mixtures thereof, in which R₁, R₃ and R₅ are independently hydrocarbon; R₂, R₄, R₆ and R₇ are independently hydrocarbon or hydrocarbonoxy; X₁, X₂ and X₃ are halogen; m and r are 0 or integers from 1 to 4, and n and p are integers from 1 to 30.

22. The composition of claim 15, wherein the phosphorus based flame retardant is bis(diphenyl phosphate), bisphenol A bis(diphenyl phosphate), N,N′-bis[di-(2,6-xylyl)phosphoryl]-piperazine or a combination comprising at least one of the phosphorus based flame retardants.

23. The composition of claim 15, comprising about 1 to about 9 wt % of the flame retardant composition and about 1 to about 9 wt % of the synergist composition.

24. A method comprising:
melt blending a composition comprising:
a polycarbonate composition; a fibrous reinforcing composition comprising glass fibers or a combination of glass fibers and carbon fibers; and a flame retardant composition comprising a phosphorus based flame retardant composition and a synergist composition; wherein the composition has a flame retardancy of V-1 or better at a sample thickness of up to about 1.6 millimeters, as measured in a UL-94 test and a heat distortion temperature of greater than or equal to about 75° C. when subjected to a deforming force of about 1.8 megapascals.

25. The method of claim 24, further comprising extruding the composition.

26. The method of claim 25, wherein the extruding is conducted in a twin screw extruder.

27. The method of claim 25, further comprising injection molding the composition.

28. An article manufactured by the method of claim 25.
